(19) United States
(12) Patent Application Publication
(10) Pub. No.: US 2003/0202673 A1
(43) Pub. Date: Oct. 30, 2003

(54) Electroacoustic transducer

(75) Inventors: Kazushige Tajima, Shizuoka (JP); Yoshiharu Oishi, Shizuoka (JP); Takaharu Kato, Shizuoka (JP)

Correspondence Address: SUGHRUE MION, PLLC, 2100 PENNSYLVANIA AVENUE, N.W., WASHINGTON, DC, 20037, US

(73) Assignee: STAR MICRONICS CO., LTD.

(21) Appl. No.: 10/422,948

(22) Filed: Apr. 25, 2003

(30) Foreign Application Priority Data
Apr. 30, 2002 (JP) P2002-127940

(51) Int. Cl. H04R 25/00; H04R 1/02; H04R 1/00; H04R 9/06; H04R 11/02

(52) U.S. Cl. 381/386; 381/152; 381/191; 381/396; 381/431

(57) ABSTRACT

A dynamic electroacoustic transducer adapted to be surface-mounted on a printed circuit board comprises a diaphragm, a synthetic resin frame for supporting the diaphragm at the periphery thereof, a surface-mounting terminal member mounted on the frame, and a synthetic resin cover with a sound emitting hole fixed to the frame so as to cover the diaphragm. Since the frame and the cover are made of synthetic resin of lower heat conductivity, the electroacoustic transducer is allowed to be subject to reflow soldering when it is surface-mounted on a printed circuit board without a damage to the diaphragm and the magnet.

### BACKGROUND OF THE INVENTION

1. Field of the Invention

The present invention relates to a dynamic electroacoustic transducer, particularly to a dynamic electroacoustic transducer adapted to be surface-mounted on a printed circuit board.

2. Description of the Related Art

A miniature electroacoustic transducer such as a speaker and a microphone is mostly adapted to be mounted on a printed circuit board. Paricularly, an electroacoustic transducer which is surface-mounted on a printed circuit board is known, as in JP-B-7-117836 for example.

In such a dynamic electroacoustic transducer, a frame is provided to support the diaphragm at the periphery thereof. A metal cover having a sound emitting hole formed thereon is fixed to the frame so as to cover the diaphragm so that the diaphragm is protected from a finger or other member.

Such conventional electroacoustic transducer is, however, not allowed to be subject to reflow soldering when it is surface-mounted on a printed circuit board. Since the metal cover is of higher heat conductivity, it would be considerably heated during reflow soldering so that radiation heat thereof could deform the diaphragm or degauss the magnet.

The “reflow soldering” refers to a soldering method wherein an electroacoustic transducer is placed on a printed circuit board having a solder paste thereon and it is subject to heat treatment at a high temperature for a short period of time (for 5 to 20 seconds at 200 to 250° C., for example), thereby a terminal plate of the electroacoustic transducer is fixed and electrically connected on a conductive portion of the printed circuit board.

### SUMMARY OF THE INVENTION

An object of the present invention is to provide a dynamic electroacoustic transducer, which is adapted to be surface-mounted on a printed circuit board by reflow soldering.

The present invention achieves the object by providing a frame and a cover made of synthetic resin.

A dynamic electroacoustic transducer adapted to be surface-mounted on a printed circuit board comprises a diaphragm having a voice coil attached thereto, a frame for supporting the diaphragm at the periphery thereof, and a surface-mounting terminal member mounted on the frame. The frame is made of synthetic resin, and a cover made of synthetic resin and having a sound emitting hole is fixed to the frame so as to cover the diaphragm.

The “electroacoustic transducer” is not limited to a particular structure as far as it is a dynamic electroacoustic transducer. It may be a speaker, a buzzer, a microphone, and a receiver, for example.

The “diaphragm” is not limited to a particular structure as far as it is applicable in the dynamic electroacoustic transducer.

The “voice coil” is not limited to a particular structure as far as it is applicable in the dynamic electroacoustic transducer.

The “terminal member” is not limited to a particular structure as far as it is adapted to be surface contact with a conductive portion of the printed circuit board when the electroacoustic transducer is surface-mounted on the printed circuit board.

The “cover” and the “frame” are made of synthetic resin. Any kind of synthetic resin may be applicable as far as it is allowed to be subject to reflow soldering.

In the electroacoustic transducer of the present invention, the frame supporting the periphery of the diaphragm is made of synthetic resin, and a cover is fixed to the frame so as to cover the diaphragm. The cover is made of synthetic resin, having a sound emitting hole formed thereon. This structure has the following advantages.

Since synthetic resin is considerably low in heat conductivity compared with metal, the frame and the cover both made of synthetic resin are prevented from being overheated when the electroacoustic transducer is subject to reflow soldering. It would effectively prevent deformation of the diaphragm and degauss of the magnet due to radiation heat from the frame and the cover.

Thus, the dynamic electroacoustic transducer of the present invention is allowed to be surface-mounted on the printed circuit board by reflow soldering.

A micro through hole is provided in one of the frame and the diaphragm to allow the back space of the diaphragm to communicate with the atmosphere. When the electroacoustic transducer is subject to reflow soldering, the micro through hole would prevent an abnormal rise in inner pressure of the back space due to thermal expansion of air. The sound characteristics of the electroacoustic transducer 10 is not affected by the micro through hole since the inner diameter thereof is set to a small value of less than φ1 mm. Preferably, it may be less than φ0.5 mm as far as the micro through hole serves as a pressure adjustment means.

The terminal member may be integrally formed with the frame by insert molding to further enhance the mounting strength of the member to the frame. The leading ends of the terminal member may be easily extended in plane with the board facing surface 20b, thereby allowing the electroacoustic transducer to be thinner in appearance and to be more suitable for surface mounting.

The frame and the cover may be preferably shaped like a rectangle. Such electroacoustic transducer is easy to be oriented, thereby allowed to be positioned on the printed circuit board with accuracy.

### BRIEF DESCRIPTION OF THE DRAWINGS

FIG. 1A is a plan view of an electroacoustic transducer of the present invention.

FIG. 1B is a bottom view of the electroacoustic transducer of the present invention.

FIG. 2A is a view seen from the IIa direction in FIG. 1.

FIG. 2B is a view seen from the IIb direction in FIG. 1.

FIG. 3 is a sectional view of the III-III line in FIG. 1.

FIG. 4 is a plan view of the electroacoustic transducer with the cover removed.

FIG. 5 is an detailed drawing of the V part in FIG. 4.

FIG. 6 is a sectional view of the VI-VI line in FIG. 5.

### DETAILED DESCRIPTION OF THE INVENTION

the present invention will be described below in detail with reference to the accompanying drawings.

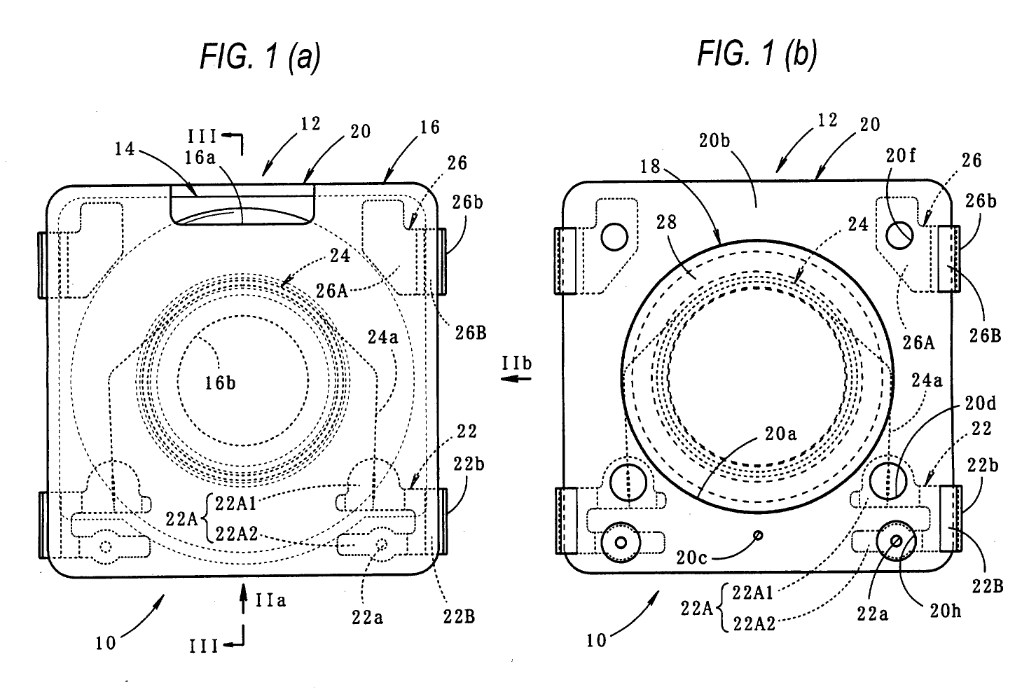

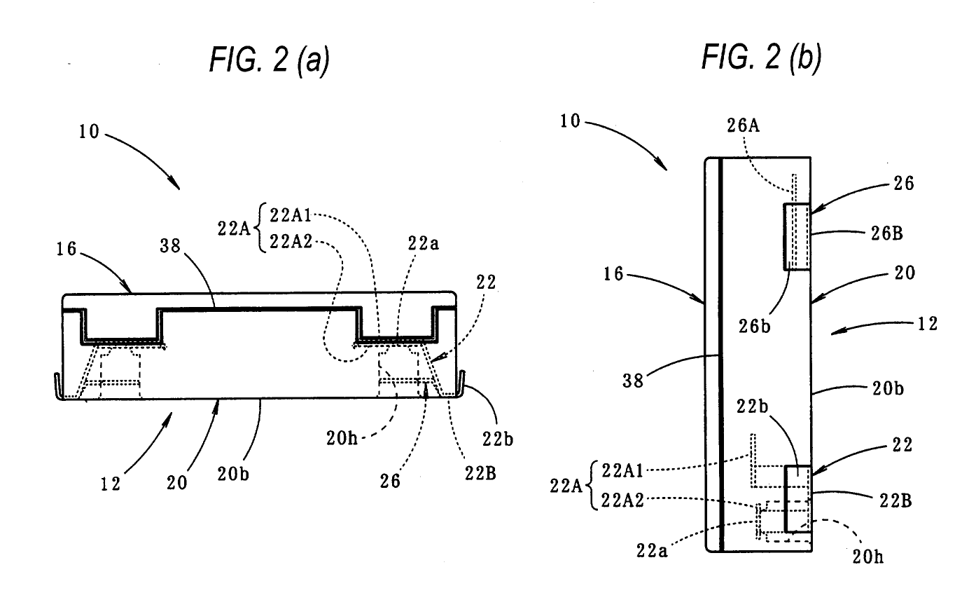

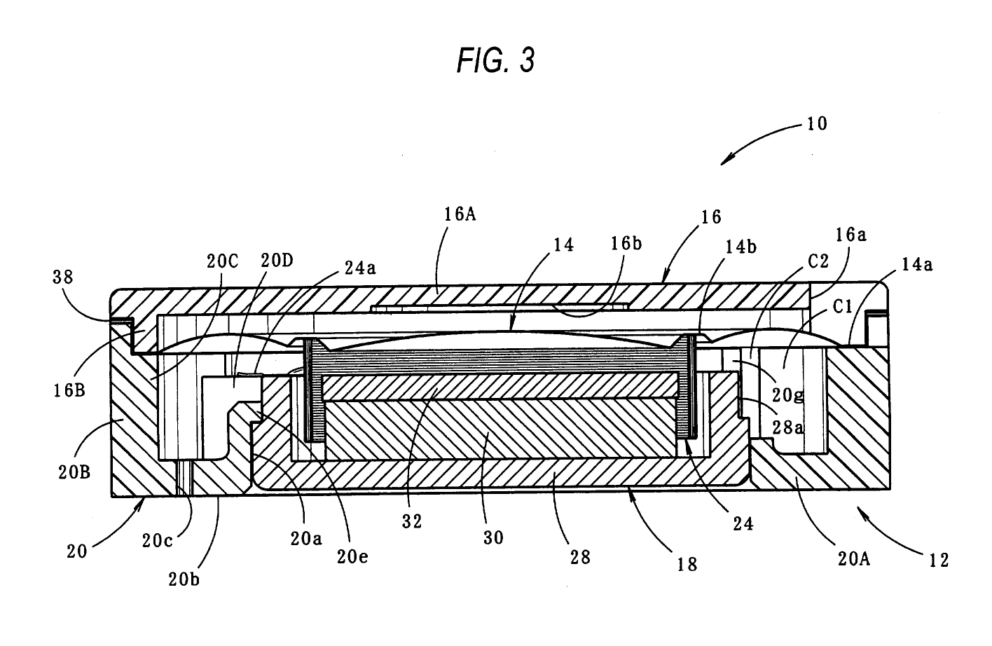

FIG. 1A is a plan view of an electroacoustic transducer 10 of the present invention and FIG. 1B is a bottom view thereof. FIG. 2A is a view seem from the IIa direction in FIG. 1A, and FIG. 2B is from the IIb direction. FIG. 3 is a sectional view of the III-III line in FIG. 1A.

As shown in these drawings, the electroacoustic transducer 10 of the present invention is a miniature dynamic speaker which is adapted to be mounted on a printed circuit board of an electronic equipment such as a mobile phone. The electroacoustic transducer 10 is surface-mounted on the printed circuit board. It may be mounted thereon by spring pressure by use of a coil spring.

The electroacoustic transducer 10 comprises a frame subassembly 12, a diaphragm 14 and a cover 16 respectively mounted on the upper side of the frame subassembly 12, and a magnetic circuit unit 18 mounted on the lower side of the frame subassembly 12.

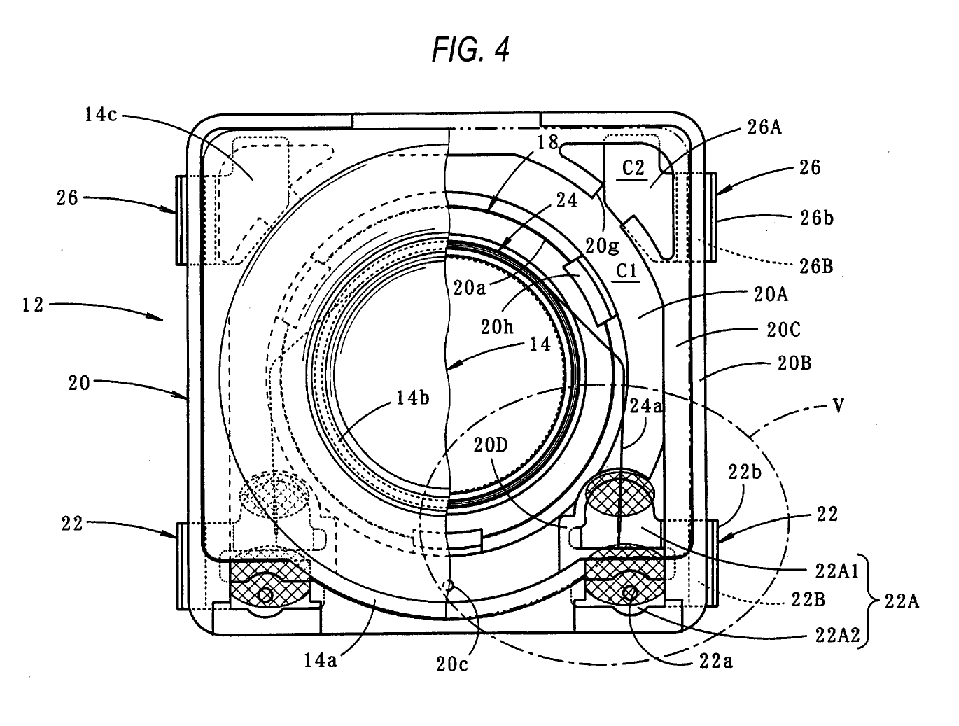

FIG. 4 is a plan view of the electroacoustic transducer 10 with the cover 16 removed.

The frame subassembly 12 comprises a frame 20, a pair of terminal plates 22, a voice coil 24, and a pair of dummy terminal plates 26.

The frame 20 is injection molded and made of polyamide resin. It has the shape of a near square in a plan view of a side of about 15 mm

The frame 20 comprises a bottom wall 20A and a side wall 20B extending upward from the outer edge of the bottom wall 20A. There is formed at the center of the bottom wall 20A a circular opening 20a for mounting the magnetic circuit unit 18 in it. A lower surface 20b of the bottom wall 20A constitutes a board facing surface which is opposite the printed circuit board when the electroacoustic transducer 10 is mounted thereon. The board facing surface 20b is positioned slightly lower than the lower surface of the magnetic circuit unit 18.

Inside the side wall 20B, there is formed on the frame 20 a diaphragm supporting portion 20C which extends from the bottom wall 20A concentrically with respect to the circular opening 20a. A diaphragm 14 is placed on the upper surface of the diaphragm supporting portion 20C to be adhered thereto. Thereby, there is formed a back space C1 at the back (lower) side of the diaphragm 14.

The pair of terminal plates 22 are embedded at two corners inside the side wall 20B and the pair of dummy terminal plates 26 are embedded at the other two corners.

At the two corners where the terminal plates 22 are embedded, a pair of terminal embedding portions 20D are formed extending from the bottom wall 20A at a height slightly lower than the diaphragm supporting portion 20C.

At the other two corners where the dummy terminal plates 26 are embedded, a pair of additional space C2 is formed so as to communicate with the back space C1. The additional space C2 is formed by cutting a near triangle piece away from the diaphragm supporting portion 20C and forming a slit 20g at inner side of the cut portion. The additional space C2 is divided from the atmosphere when the diaphragm 14 is placed and fixed on the diaphragm supporting portion 20C.

The terminal plate 22 and the dummy terminal plate 26 are pressed and bent metals. They are integrally formed with the frame 20 by manufacturing the frame subassembly 12 by insert molding. Abase portion 22A of the terminal plate 22 is exposed on the upper surface of the terminal embedding portion 20D and a leading portion 22B thereof is exposed on the board facing surface 20b. A base portion 26A of the dummy terminal plate 26 is exposed on the additional space C2 and a leading portion 26B thereof is exposed on the board facing surface 20b.

The leading portion 22B of the terminal plate 22 and the leading portion 26B of the dummy terminal plate 26B are coplanar with the board facing surface 20b and extended to the outside of the side wall 20B. They are bent upward a little along the outer surface of the side wall 20B as projecting piece 22b and 26b respectively. The projecting pieces 22b and 26b are formed of leftover strip after insert molding of the frame subassembly 12. The projecting strip from the side wall 20B is cut at a predetermined position and bent into the projecting pieces 22b and 26b.

There are formed at the bottom wall 20A a pair of columnar holes 20d and a pair of columnar holes 20f extending from the board facing surface 20b to the terminal plate 22 and the dummy terminal plate 26 respectively. They are formed by an insert holding jig when the frame subassembly 12 is insert molded.

The diaphragm 14 is made of polyimide resin film by thermal press molding, having a plurality of irregularity concentric to each other. There are formed a peripheral flat portion 14a (periphery) and an intermediate flat portion 14b. The diaphragm 14 is bonded to the upper surface of the diaphragm supporting portion 20C at the peripheral flat portion 14a and bonded to the upper end of the voice coil 24 at the intermediate flat portion 14b. At the corners where the dummy terminal plates 26 are embedded, the peripheral flat portion 14a is extended toward outside to form an extended portion 14c. The extended portion 14c divides the additional space C2 from the atmosphere above the diaphragm 14.

The cover 16 is injection molded and made of polyamide resin, having the substantially same dimensions as the frame 20.

The cover 16 comprises a top wall 16A and a side wall 16B extending downward from the outer edge of the top wall 16A. A sound emitting hole 16a of a rectangular shape is formed on the outer edge of the top wall 16A. The sound emitting hole 16a is formed by cutting part of the side wall 16B between the two corners where the dummy terminal plates 26 are embedded. The cover 16 is, at the side wall 16B, adhered to the side wall 20B of the frame 20 by adhesive 38. There is formed a circular recess 16b at the center of the top wall 16A on the lower side thereof to prevent interference with the diaphragm 14 when the diaphragm 14 is vibrated.

The magnetic circuit unit 18 comprises a steel base 28, a magnet 30, and a steel yoke 32.

The base 28 has the shape of a bottomed cylinder. An annular recess 28a is formed at the upper circumference thereof. The magnet 30 is a Neodymium sintered magnet (Nd—Fe—B sintered magnet) having a nickel plating on it. It is disc-shaped and concentrically adhered to the upper surface of the bottom of the base 28. The yoke 32 is disc-shaped, having a slightly larger diameter than the magnet 30. It is concentrically adhered to the upper surface of the magnet 30. A cylindrical magnetic gap is thereby formed between the outer surface of the yoke 32 and the inner surface of the base 28, having the same width over the entire circumference so as to accommodate a lower portion of the voice coil 24 in the gap.

The magnetic circuit unit 18 is fitted into the circular opening 20a from below and adhered to the bottom wall 20A. There are circumferentially formed at equal intervals around the circular opening 20a three positioning pieces 20e for engaging with the annular recess 28a to support the magnetic circuit unit 18.

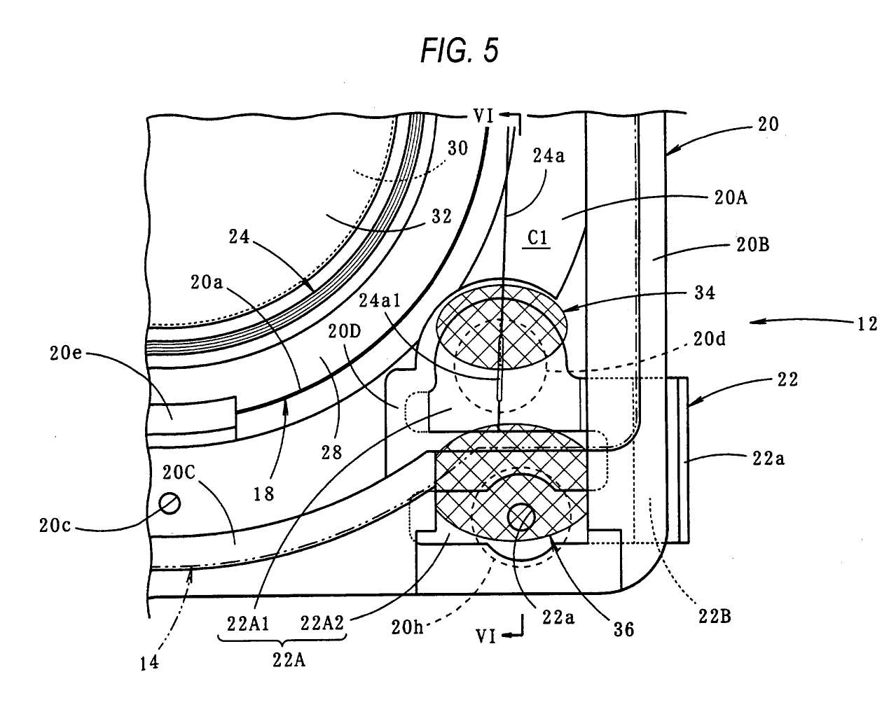

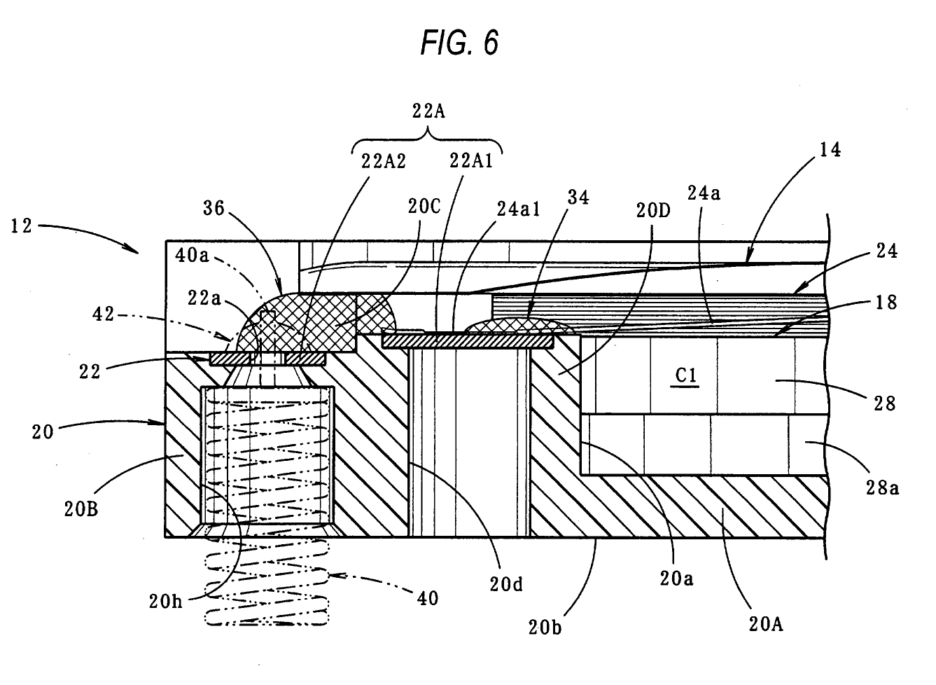

FIG. 5 is a detailed drawing of the V part in FIG. 4. FIG. 6 is a sectional view of the VI-VI line in FIG. 4.

The terminal plate 22 is divided into two portions toward the base portion 22A, thereby having two divided portions 22A1 and 22A2 exposed on the upper surface of the terminal embedding portion 20D. The inner divided portion 22A1 constitutes a conductive fixing portion for a coil terminal 24a of the voice coil 24. The outer divided portion 22A2 constitutes a coil spring mounting portion having a small hole 22a.

The conductive fixing portion 22A1 and the coil spring mounting portion 22A2 are in the shape of a land and substantially coplanar with the upper surface of the terminal embedding portion 20D. The upper surface of the terminal embedding portion 20D where the conductive fixing portion 22A1 is exposed is slightly higher than the upper surface thereof where the coil spring mounting portion 22A2 is exposed.

The voice coil 24 is disposed in the circular opening 20a so that the upper end thereof is substantially coplanar with the upper surface of the diaphragm supporting portion 20C. The pair of coil terminals 24a drawn from the upper end of the voice coil 24 is fixed and electrically connected on the conductive fixing portion 22A1 by thermally pressing the coil terminal 24a at a portion near the leading end thereof. An overcoat 34 is applied on the conductive fixing portion 22A1 to cover the border area between the thermally pressed portion and the other part of the voice coil 24.

The diaphragm supporting portion 20C and the side wall 20B are partially cut away to expose the upper surface of the terminal embedding portion 20D to allow the coil terminal 24a to be fixed thereto. A sealing agent 36 is filled between the terminal embedding portion 20D and the diaphragm 14 fixed on the diaphragm supporting portion 20C, thereby the back space C1 is a sealed space divided from the atomosphere.

The bottom wall 20A has a micro through hole 20c for allowing communication of the back space C1 with the atmosphere to prevent a variation in inner pressure in the back space C1. The micro through hole 20c may be of a micro-sized inner diameter of less than φ1 mm (preferably less than φ0.5 mm) as far as it serves as an inner pressure adjuster.

When the coil terminal 24a is thermally pressed on the conducive fixing portion 22A1, a supporting jig (metal pin) is inserted into the columnar hole 20d formed below the conductive fixing portion 22A1 in the terminal embedding portion 20D.

A cylindrical recess 20h is formed extending from the board facing surface 20b to the terminal plate 22 below (at the back side of) the coil spring mounting portion 22A2 in the terminal embedding portion 20D. The middle part of the cylindrical recess 20h is formed in the shape of a cylinder enclosing the small hole 22a of the terminal plate 22. The lower part thereof is conically expanded toward the board facing surface 20b and the upper part thereof is tapered toward the terminal plate 22.

The electroacoustic transducer 10 of the present invention is adapted to be surface-mounted on the printed circuit board. Alternatively, it may be adapted to be mounted on the printed circuit board by spring pressure by a coil spring. In the latter case, as shown in the chain double-dashed line in FIG. 6, a coil spring 40 is inserted into the cylindrical recess 20h with the leading end 40a thereof inserted into the small hole 22a to be fixed on the coil spring mounting portion 22A2 of the terminal plate 22. The leading end 40a of the coil spring 40 is soldered on the upper surface of the coil spring mounting portion 22A2 by solder 42.

The coil spring 40 has the length longer than the length of the cylindrical recess 20h by predetermined dimensions and the diameter smaller than the inner diameter of the cylindrical recess 20h by predetermined dimensions. The coil spring 40 is made of stainless steel with nickel or gold plating on it.

As described above, in the electroacoustic transducer 10 of the present invention, the frame 20 for supporting the peripheral flat portion 14a of the diaphragm 14 is made of synthetic resin, and a cover having a sound emitting hole 16a is made of synthetic resin and fixed to the frame 20 so as to cover the diaphragm 14. Therefore, the present invention provides the following advantages.

Since synthetic resin is considerably low in heat conductivity compared with metal, the frame 20 and the cover 16 both made of synthetic resin are prevented from being overheated when the electroacoustic transducer is subject to reflow soldering. It would effectively prevent deformation of the diaphragm 14 and degauss of the magnet 30 due to radiation heat from the frame 20 and the cover 16.

A dynamic electroacoustic transducer of the present invention is allowed to be surface-mounted on the printed circuit board by reflow soldering.

In the preferred embodiment, since the diaphragm 14 is made of polyimide resin of higher heat resistance, deformation of the diaphragm 14 is more effectively prevented. Since the magnet 30 is made of Neodymium sintered magnet of higher heat resistance, degauss of the magnet 30 is more effectively prevented.

In this embodiment, the back space C1 is not a closed space since the micro through hole 20c is formed on the bottom wall 20A to allow the back space C1 to communicate with the atmosphere. The micro through hole 20c prevents variation in inner pressure of the back space C1. When the electroacoustic transducer is subject to reflow soldering, an abnormal rise in inner pressure of the back space C1 due to thermal expansion of air is prevented.

The sound characteristics of the electroacoustic transducer 10 is not affected by the micro through hole 20c since the inner diameter thereof is set to a small value of less than φ1 mm. Preferably, it may be less than φ0.5 mm as far as the micro through hole 20c serves as a pressure adjustment means. The micro through hole 20c may be integrally formed with the frame 20, or may be separately formed, for example, by radiation of laser beam. The inner diameter size of the micro through hole can be made smaller in the latter method.

Instead of the micro through hole 20c, a micro gap may be formed between the frame 20 and the diaphragm 14 as far as it serves as an inner pressure adjustment means for the back space C1.

In the embodiment described above, since the frame 20 and the cover 16 are shaped like a rectangle, the electroacoustic transducer 10 is easily positioned directionally. Therefore, the electroacoustic transducer 10 is accurately positioned on the printed circuit board in reflow soldering.

The sound emitting hole 16a may be formed at another position (at the center of the top wall 16A, for example) instead of the outer edge of the top wall 16A in this embodiment.

The pair of terminal plates 22 and the pair of dummy terminal plates 26 are provided on the corners of the frame 20. The leading end 26B of the dummy plate 26 extends toward the board facing surface 20b as the leading end 22B of the terminal plate 22 does. The electroacoustic transducer 10 can be securely mounted on the printed circuit board by solder at the four corners, thus improving mounting strength.

Further, the leading ends 22B and 26B are substantially coplanar with the board facing surface 20b, and extend toward the outside of the side wall 20B. They further slightly extend upward along the side wall 20B as the projection pieces 22b and 26b respectively. The terminal plate 22 and the dummy terminal plate 26 may be soldered on the printed circuit board at the sides of the projection pieces 22b and 26b as well as at the lower surfaces of the leading ends 22B and 26B, thus improving mounting strength.

The terminal plate 22 and the dummy terminal plate 26 may be integrally formed with the frame 20 by insert molding to further enhance the mounting strength of the plates to the frame 20. The leading ends 22B and 26B may be easily extended in plane with the board facing surface 20b, thereby allowing the electroacoustic transducer 10 to be thinner and to be more suitable for surface mounting.

What is claimed is:

1. A dynamic electroacoustic transducer adapted to be surface-mounted on a printed circuit board, comprising:
a diaphragm having a voice coil attached thereto;
a frame for supporting the diaphragm at the periphery thereof; and
a surface-mounting terminal member mounted on the frame;
wherein the frame is made of synthetic resin, and
a cover made of synthetic resin and having a sound emitting hole is fixed to the frame so as to cover the diaphragm.

2. The electroacoustic transducer as claimed in claim 1, wherein a micro through hole is formed in one of the frame and the diaphragm to allow communication of a back space of the diaphragm with the atmosphere.

3. The electroacoustic transducer as claimed in claim 1, wherein the terminal member is integrally formed with the frame by insert molding.

4. The electroacoustic transducer as claimed in claim 2, wherein the terminal member is integrally formed with the frame by insert molding.

5. The electroacoustic transducer as claimed in claim 1, wherein each of the frame and the cover has substantially the shape of a rectangle.

6. The electroacoustic transducer as claimed in claim 2, wherein each of the frame and the cover has substantially the shape of a rectangle.

7. The electroacoustic transducer as claimed in claim 3, wherein each of the frame and the cover has substantially the shape of a rectangle.
